(19) United States
(12) Patent Application Publication
(10) Pub. No.: US 2024/0053450 A1
(43) Pub. Date: Feb. 15, 2024

(54) RANGING DEVICE

(71) Applicant: CANON KABUSHIKI KAISHA, Tokyo (JP)

(72) Inventor: YUUTA OOSHIMA, Saitama (JP)

(21) Appl. No.: 18/364,813

(22) Filed: Aug. 3, 2023

(30) Foreign Application Priority Data
Aug. 12, 2022 (JP) 2022-128616

(51) Int. Cl. G01S 7/4865; G01S 17/931; B60W 30/09

(52) U.S. Cl. CPC G01S 7/4865; G01S 17/931; B60W 30/09; G01S 7/4863

(57) ABSTRACT

A ranging device including: a frequency distribution storage unit that stores a frequency distribution of the number of pulses detected in each predetermined bin period in time counting for each photoelectric conversion element; a region setting unit that sets a first region in which a part of the photoelectric conversion elements is arranged and a second region in which another part of the photoelectric conversion elements is arranged; and a storage condition setting unit that sets a storage condition of frequency distributions so that a class width of a first bin in a first frequency distribution corresponding to a photoelectric conversion element of the first region and a class width of a second bin in a second frequency distribution corresponding to a photoelectric conversion element of the second region are different and so that a storage capacity for the first and second frequency distributions does not exceed a predetermined value.

### BACKGROUND OF THE INVENTION

### Field of the Invention

The present disclosure relates to a ranging device.

### Description of the Related Art

Japanese Patent Application Laid-Open No. 2020-505602 discloses a ranging device that measures a distance to an object based on a time difference between a time at which light is irradiated and a time at which reflected light is received. The ranging device disclosed in Japanese Patent Application Laid-Open No. 2020-505602 calculates a distance from a frequency distribution of a count value of incident light with respect to time from light emission. This frequency distribution is configured such that a bin corresponding to longer distance has a wider range of distances assigned to one bin. This makes it possible to make the sensitivity or resolution different depending on the distance. Further, Japanese Patent Application Laid-Open No. 2020-505602 discloses that the sensitivity of a portion in a pixel array can be modulated in a manner different from that of another portion.

Japanese Patent Application Laid-Open No. 2020-091117 discloses a ranging device capable of operating in a plurality of pixel modes. The ranging device can operate in a plurality of pixel modes in which the resolution and the ranging area are different from each other. Storage areas of different sizes are assigned to different pixel modes. Thus, it is disclosed that memory resources can be efficiently utilized.

There is a case where a technique capable of further reducing a storage area is required in a ranging device such as Japanese Patent Application Laid-Open No. 2020-505602 or Japanese Patent Application Laid-Open No. 2020-091117.

### SUMMARY OF THE INVENTION

An object of the present disclosure is to provide a ranging device capable of further reducing a storage area required for storing a frequency distribution.

According to a disclosure of the present specification, there is provided a ranging device including: a light receiving unit configured to generate a light reception count value corresponding to each of a plurality of photoelectric conversion elements by counting pulses based on incident light to each of the plurality of photoelectric conversion elements; a time counting unit configured to count elapsed time; a frequency distribution storage unit configured to store a frequency distribution of the number of pulses detected in each predetermined bin period in time counting for each of the plurality of photoelectric conversion elements; a region setting unit configured to set a first region in which a part of the plurality of photoelectric conversion elements is arranged and a second region in which another part of the plurality of photoelectric conversion elements is arranged; and a storage condition setting unit configured to set a storage condition of frequency distributions so that a class width of a first bin in a first frequency distribution corresponding to a photoelectric conversion element of the first region and a class width of a second bin in a second frequency distribution corresponding to a photoelectric conversion element of the second region are different and so that a storage capacity in which the first frequency distribution and the second frequency distribution are stored in the frequency distribution storage unit does not exceed a predetermined value.

Further features of the present invention will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a schematic view illustrating an overall configuration of a photoelectric conversion device according to the first embodiment.

FIG. 3 is a schematic block diagram illustrating a configuration example of a sensor substrate according to the first embodiment.

FIG. 4 is a schematic block diagram illustrating a configuration example of a circuit substrate according to the first embodiment.

FIG. 5 is a schematic block diagram illustrating a configuration example of one pixel of a photoelectric conversion unit and a pixel signal processing unit according to the first embodiment.

FIGS. 6A, 6B, and 6C are diagrams illustrating an operation of the avalanche photodiode according to the first embodiment.

FIG. 7 is a functional block diagram illustrating a schematic configuration example of the ranging device according to the first embodiment.

FIG. 8 is a diagram illustrating an outline of an operation of the ranging device in one ranging period according to the first embodiment.

FIGS. 9A, 9B, 9C, and 9D are histograms visually illustrating frequency distributions of pulse count values according to the first embodiment.

FIG. 10 is a flowchart illustrating an operation of the ranging device according to the first embodiment.

FIG. 11 is a schematic diagram illustrating an example of setting regions according to the first embodiment.

FIGS. 12A, 12B, and 12C are histograms visually illustrating an example of frequency distribution of each region according to the first embodiment.

FIG. 13 is a schematic diagram illustrating an example of assignment of addresses according to the first embodiment.

FIG. 14 is a flowchart illustrating a region determination processing according to the first embodiment.

FIG. 15 is a flowchart illustrating offset calculation processing according to the first embodiment.

FIG. 16 is a flowchart illustrating an address calculation processing according to the first embodiment.

FIG. 17 is a schematic diagram illustrating an arrangement example of regions and pixels according to the first embodiment.

FIG. 18 is a schematic diagram illustrating an arrangement example of sub-regions according to the first embodiment.

FIG. 19 is a schematic diagram illustrating an example of assignment of addresses according to the first embodiment.

FIG. 20 is a schematic diagram illustrating an example of assignment of addresses according to the first embodiment.

FIG. 21 is a schematic diagram illustrating an example of setting the distance resolution according to a second embodiment.

FIGS. 22A, 22B, and 22C are histograms visually illustrating an example of frequency distribution of each region according to the second embodiment.

FIG. 23 is a schematic diagram illustrating an example of assignment of addresses according to the second embodiment.

FIG. 24 is a flowchart illustrating offset calculation processing according to the second embodiment.

FIG. 25 is a flowchart illustrating an address calculation processing according to the second embodiment.

FIG. 26 is a functional block diagram illustrating a schematic configuration example of a ranging device according to a third embodiment.

FIGS. 27A, 27B, and 27C are schematic diagrams illustrating an example of changing the setting of the regions according to the third embodiment.

FIG. 28 is a schematic diagram illustrating an example of setting regions according to a fourth embodiment.

FIG. 29 is a schematic diagram illustrating an example of setting regions according to the fourth embodiment.

FIGS. 30A, 30B, and 30C are histograms visually illustrating an example of frequency distribution of each region according to the fourth embodiment.

FIG. 31 is a flowchart illustrating a region changing method according to the fourth embodiment.

FIG. 32 is a flowchart illustrating a determination method of the number of bins according to the fourth embodiment.

FIGS. 33A and 33B are schematic diagrams of equipment according to a fifth embodiment.

### DESCRIPTION OF THE EMBODIMENTS

Preferred embodiments of the present invention will now be described in detail in accordance with the accompanying drawings. In the drawings, the same or corresponding elements are denoted by the same reference numerals, and the description thereof may be omitted or simplified.

### First Embodiment

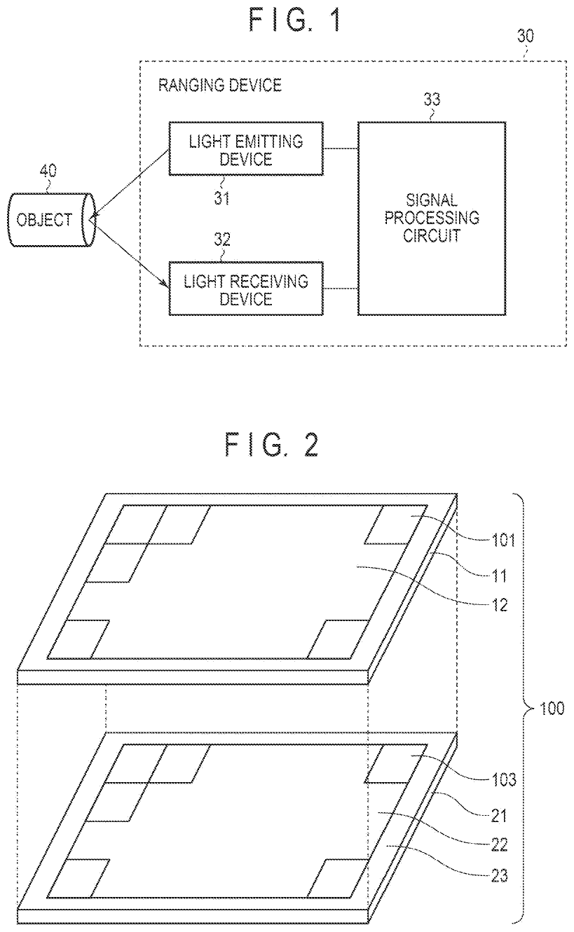

FIG. 1 is a hardware block diagram illustrating a schematic configuration example of a ranging device 30 according to the present embodiment. The ranging device 30 includes a light emitting device 31, a light receiving device 32, and a signal processing circuit 33. Note that the configuration of the ranging device 30 illustrated in the present embodiment is an example, and is not limited to the illustrated configuration.

The ranging device 30 measures a distance to an object 40 by using a technique such as a light detection and ranging (LiDAR). The ranging device 30 measures a distance from the ranging device 30 to the object 40 based on the time difference until the light emitted from the light emitting device 31 is reflected by the object 40 and received by the light receiving device 32.

The light received by the light receiving device 32 includes ambient light such as sunlight in addition to the reflected light from the object 40. For this reason, the ranging device 30 measures incident light in each of a plurality of periods (bin periods), and performs ranging in which influence of ambient light is reduced by using a method of determining that reflected light is incident in a period in which the amount of light peaks. The ranging device 30 of the present embodiment may be, for example, a flash LiDAR that emits laser light to a predetermined ranging area including the object 40, and receives reflected light by a pixel array.

The light emitting device 31 is a light source that emits light such as laser light to the outside of the ranging device 30. When the ranging device 30 is a flash LiDAR, the light emitting device 31 may be a surface light source such as a surface emitting laser.

The signal processing circuit 33 may include a counter for counting pulses, a processor for performing arithmetic processing of digital signals, a memory for storing digital signals, and the like. The memory may be, for example, a semiconductor memory.

The light receiving device 32 generates a pulse signal including a pulse based on the incident light. The light receiving device 32 is, for example, a photoelectric conversion device including an avalanche photodiode as a photoelectric conversion element. In this case, when one photon is incident on the avalanche photodiode and a charge is generated, one pulse is generated by avalanche multiplication. However, the light receiving device 32 may be, for example, a photoelectric conversion element using another photodiode.

In the present embodiment, the light receiving device 32 includes a pixel array in which a plurality of photoelectric conversion elements (pixels) are arranged to form a plurality of rows and a plurality of columns. A photoelectric conversion device, which is a specific configuration example of the light receiving device 32, will now be described with reference to FIGS. 2 to 6C. The configuration example of the photoelectric conversion device described below is an example, and the photoelectric conversion device applicable to the light receiving device 32 is not limited thereto.

FIG. 2 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

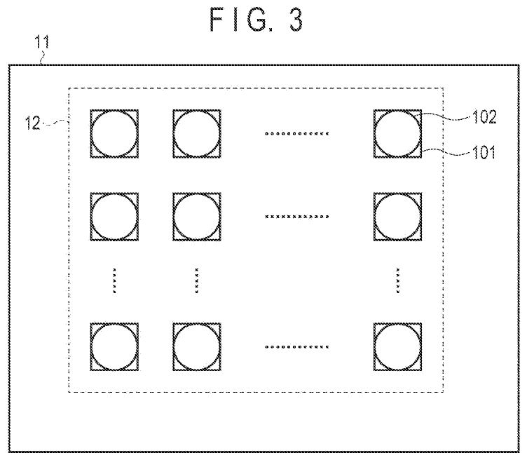

FIG. 3 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

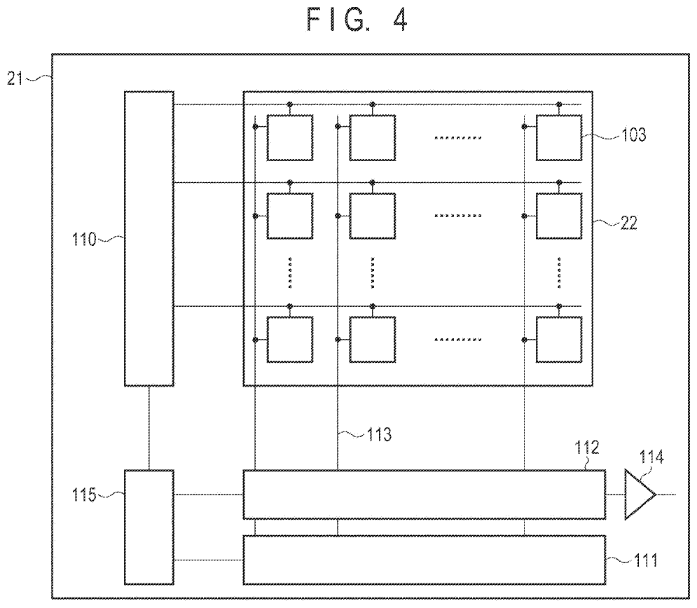

FIG. 4 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 3 and the plurality of pixel signal processing units 103 illustrated in FIG. 4 are electrically connected to each other via connection wirings provided for each pixels 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixels 101 is processed by the pixel signal processing unit 103. The pixel signal processing unit 103 acquires and holds a digital signal having a plurality of bits by counting the number of pulses output from the APD included in the photoelectric conversion unit 102.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 is not limited to the illustrated arrangement. The arrangement of the photoelectric conversion units 102 in the pixel region 12 may be one-dimensional.

As illustrated in FIGS. 3 and 4, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 (illustrated in FIG. 2) having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 3. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

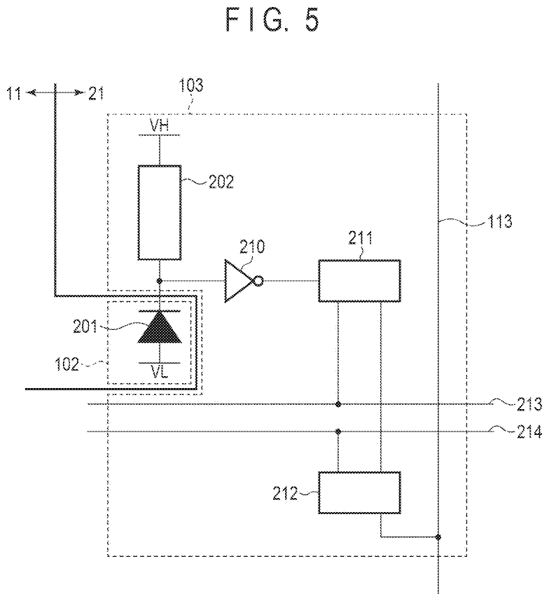

FIG. 5 is a schematic block diagram illustrating a configuration example of one pixel of the photoelectric conversion unit 102 and the pixel signal processing unit 103 according to the present embodiment. FIG. 5 schematically illustrates a more specific configuration example including a connection relationship between the photoelectric conversion unit 102 arranged in the sensor substrate 11 and the pixel signal processing unit 103 arranged in the circuit substrate 21. In FIG. 5, driving lines between the vertical scanning circuit 110 and the pixel signal processing unit 103 in FIG. 4 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates charge pairs corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 5 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulse signals output from the waveform shaping unit 210, and holds a digital signal indicating the count value. When a control signal is supplied from the vertical scanning circuit 110 illustrated in FIG. 4 through the driving line 213 illustrated in FIG. 5, the counter circuit 211 resets the held signal.

The selection circuit 212 is supplied with a control signal from the vertical scanning circuit 110 illustrated in FIG. 4 through the driving line 214 illustrated in FIG. 5. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 5, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

FIG. 5 illustrates a configuration example using the counter circuit 211. However, instead of the counter circuit 211, a time-to-digital converter (TDC) and a memory may be used to acquire a timing at which a pulse is detected. In this case, the generation timing of the pulsed signal output from the waveform shaping unit 210 is converted into a digital signal by the TDC. In this case, a control signal (reference signal) can be supplied from the vertical scanning circuit 110 illustrated in FIG. 4 to the TDC via the driving line. The TDC acquires, as a digital signal, a signal indicating a relative time of input timing of a pulse with respect to the control signal.

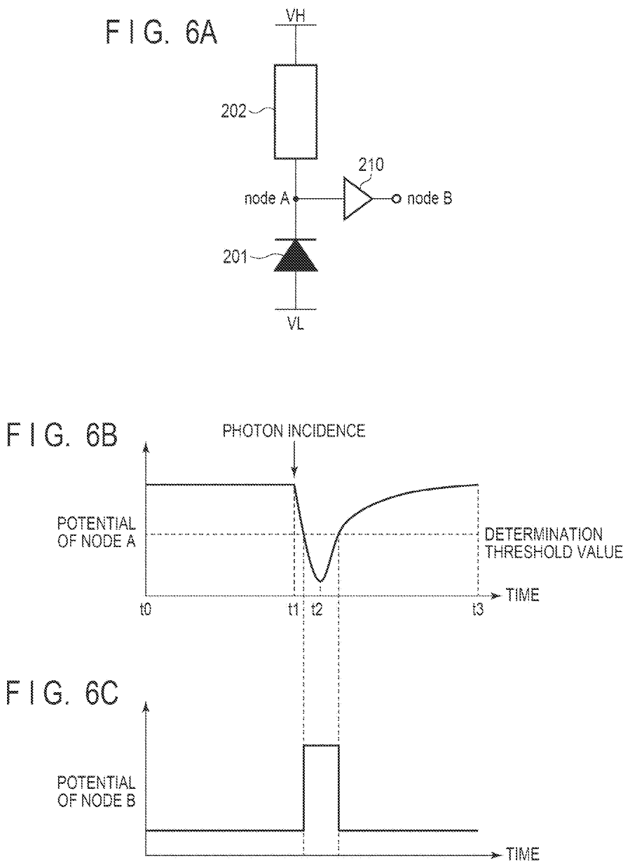

FIGS. 6A, 6B, and 6C are diagrams illustrating an operation of the APD 201 according to the present embodiment. FIG. 6A is a diagram illustrating the APD 201, the quenching element 202, and the waveform shaping unit 210 in FIG. 5. As illustrated in FIG. 6A, the connection node of the APD 201, the quenching element 202, and the input terminal of the waveform shaping unit 210 is referred to as node A. Further, as illustrated in FIG. 6A, an output side of the waveform shaping unit 210 is referred to as node B.

FIG. 6B is a graph illustrating a temporal change in the potential of node A in FIG. 6A. FIG. 6C is a graph illustrating a temporal change in the potential of node B in FIG. 6A. During a period from time t0 to time t1, the voltage VH-VL is applied to the APD 201 in FIG. 6A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

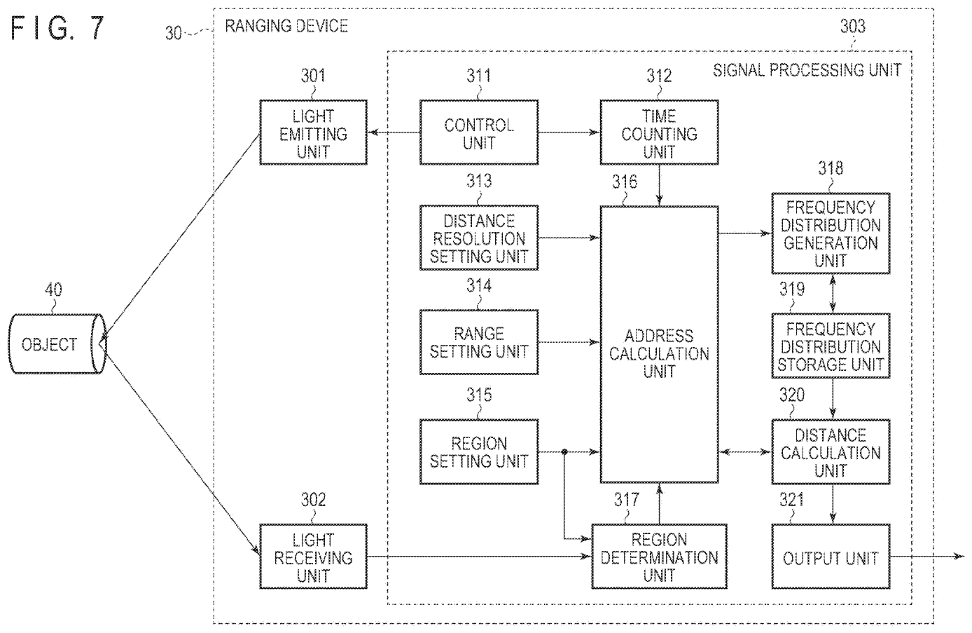

Next, the overall configuration and operation of the ranging device 30 will be described in detail. FIG. 7 is a functional block diagram illustrating a schematic configuration example of the ranging device 30 according to the present embodiment. The ranging device 30 includes a light emitting unit 301, a light receiving unit 302, and a signal processing unit 303. The light emitting unit 301, the light receiving unit 302, and the signal processing unit 303 correspond to the light emitting device 31, the light receiving device 32, and the signal processing circuit 33 in FIG. 1, respectively. The signal processing unit 303 includes a control unit 311, a time counting unit 312, a distance resolution setting unit 313, a range setting unit 314, a region setting unit 315, an address calculation unit 316, and a region determination unit 317. The signal processing unit 303 further includes a frequency distribution generation unit 318, a frequency distribution storage unit 319, a distance calculation unit 320, and an output unit 321.

The control unit 311 synchronously controls the light emission timing in the light emitting unit 301 and the start of the time counting in the time counting unit 312. The time counting unit 312 performs time counting based on the control of the control unit 311, thereby acquiring an elapsed time from a time at which counting is started as a digital signal. Thus, the time counting unit 312 can count the elapsed time from the light emission in the light emitting unit 301. The time counting unit 312 includes, for example, a circuit such as a ring oscillator and a counter, and counts a clock pulse that vibrates at a certain period to preform time counting.

The signal processing unit 303 of the present embodiment acquires a light reception count value output from each of the plurality of photoelectric conversion elements (or each of the plurality of pixels) included in the light receiving unit 302. Then, the signal processing unit 303 generates and stores a frequency distribution in which a plurality of bins determined by a time interval (bin period) based on the time count value are associated with the light reception count value in each bin. The frequency distribution is stored in the frequency distribution storage unit 319.

Further, in the present embodiment, the signal processing unit 303 has a function of dividing a plurality of photoelectric conversion elements of the light receiving unit 302 into a plurality of regions and making settings different for each region. The region setting unit 315 performs setting of ranges of the regions. The distance resolution setting unit 313 sets the distance resolution of the frequency distribution for each region. The range setting unit 314 sets the acquisition range of the frequency distribution for each region. The distance resolution setting unit 313 and the range setting unit 314 have a function of setting a storage condition of frequency distributions, and they are collectively referred to as a storage condition setting unit.

When incident light is detected in the light receiving unit 302, the region determination unit 317 determines a region to which the photoelectric conversion element that has received the incident light belongs, based on the setting of the region by the region setting unit 315. The address calculation unit 316 receives the time count value from the time counting unit 312, receives various setting information from the distance resolution setting unit 313, the range setting unit 314, and the region setting unit 315, and receives region information from the region determination unit 317. The address calculation unit 316 calculates an address (memory address) in the frequency distribution storage unit 319 for storing the light reception count value based on the incident light based on the information.

The frequency distribution generation unit 318 reads data from the frequency distribution storage unit 319 based on the address calculated by the address calculation unit 316, adds the light reception count value acquired by the light receiving unit 302 to the data, and writes the data back to the frequency distribution storage unit 319. By repeating this, the frequency distribution generation unit 318 generates a frequency distribution and stores the frequency distribution in the frequency distribution storage unit 319.

The distance calculation unit 320 reads the frequency distribution stored in the frequency distribution storage unit 319 using the address acquired from the address calculation unit 316, and converts a period in which the amount of light peaks into a distance to calculate the distance. Since this distance is calculated for each of the plurality of photoelectric conversion elements, the distance calculation unit 320 can generate a distance distribution (distance information) for each pixel. The output unit 321 outputs the distance distribution to an external device of the ranging device 30.

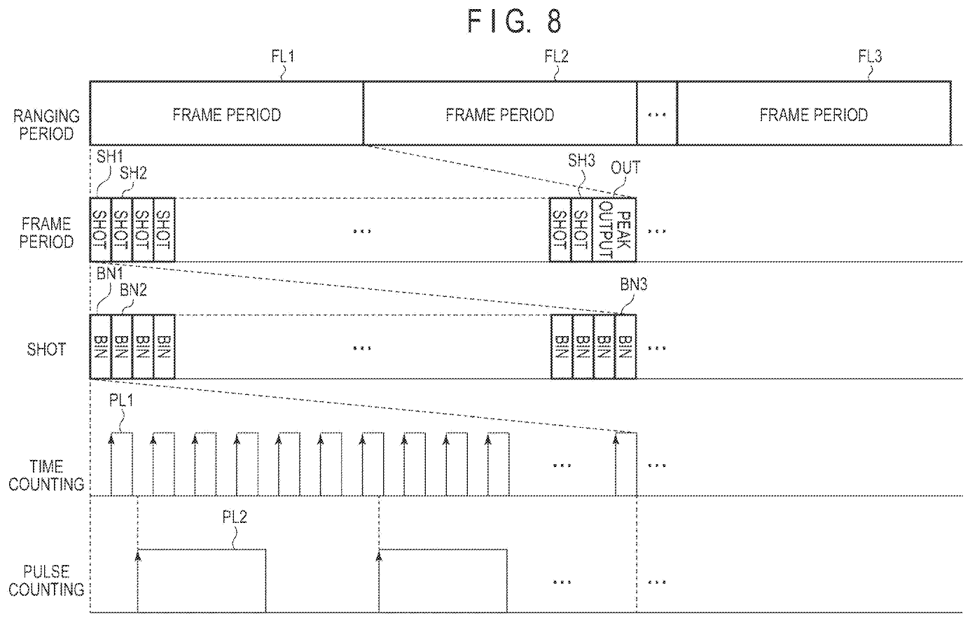

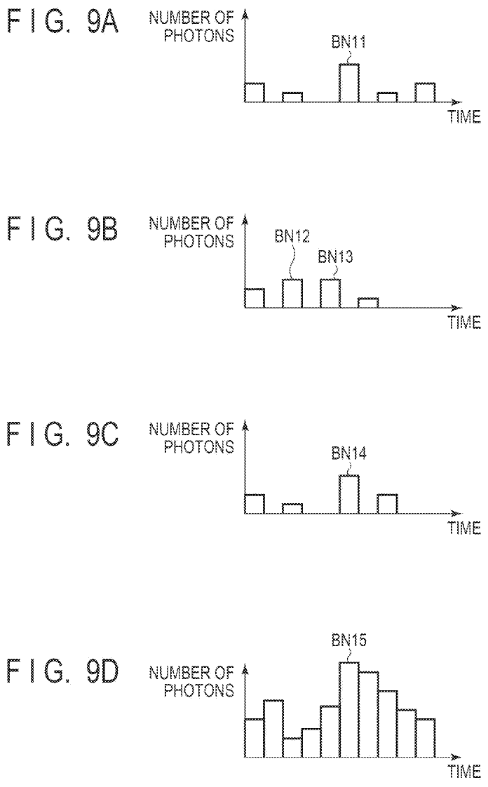

Now, with further reference to FIGS. 8 and 9A to 9D, an outline of the operation in one ranging period and a relationship between a frame period, a sub-frame period, a shot, and a bin related to the frequency distribution generated by the frequency distribution generation unit 318 will be described.

FIG. 8 is a diagram illustrating an outline of an operation of the ranging device 30 according to the present embodiment in one ranging period. In the description of FIG. 8, it is assumed that the ranging device 30 is a flash LiDAR. In the “ranging period” of FIG. 8, a plurality of frame periods included in one ranging period are illustrated. A frame period FL1 indicates a first frame period in one ranging period. The frame period is a period in which the ranging device 30 performs one ranging and outputs a signal indicating a distance (ranging result) from the ranging device 30 to the object 40 to the outside. After the frame period FL1, similar frame periods FL2, . . . , FL3 are repeated until the ranging period ends.

In the “frame period” of FIG. 8, a plurality of shots SH1, SH2, . . . , SH3 included in the frame period FL1 and a peak output OUT are illustrated. The shot is one period in which the light emitting unit 301 emits light once and the frequency distribution is updated by the light reception count value based on the light emission. The peak output OUT indicates a period during which a ranging result is output based on peaks acquired by accumulating signals of a plurality of shots.

In the “shot” of FIG. 8, a plurality of bins BN1, BN2, . . . , BN3 included in the shot SH1 are illustrated. A bin indicates one time interval during which a series of light reception counting is performed, and is a period during which a pulse based on incident light is counted to acquire a light reception count value. The bin BN1 indicates the first bin in the shot SH1. The bin BN2 indicates the second bin in the shot SH1. The bin BN3 indicates the last bin in shot SH1.

The “time counting” in FIG. 8 schematically illustrates pulses PL1 used for time counting in the time counting unit 312. As illustrated in FIG. 8, the time counting unit 312 counts the pulses PL1 that rise periodically to generate a time count value. When the time count value reaches a predetermined value, a processing of the bin BN1 ends, and the process transitions to the next bin BN2.

The “pulse counting” in FIG. 8 schematically illustrates a pulse PL2 based on incident light counted in the light receiving unit 302. When one photon is incident on the light receiving unit 302, one pulse PL2 rises. In the example of FIG. 8, two pulses rise in the period of the bin BN1, and “2” is acquired as the light reception count value of the bin BN1. Similarly, the light reception count values are sequentially acquired for the bin BN2 and after the bin BN2. As illustrated in FIG. 8, it is assumed that the frequency of the pulse PL1 of the time counting is set sufficiently higher than the frequency of the rising edge of the pulse PL2 of the pulse counting. In this case, the number of pulses PL2 can be appropriately counted.

FIGS. 9A to 9D are histograms visually illustrating the frequency distribution of the light reception count values counted in the light receiving unit 302. In this specification, the frequency distribution is frequency information corresponding to a predetermined class width, and is not necessarily displayed visually. FIGS. 9A to 9D are examples for explaining the outline of the frequency distribution, and may be different from the frequency distribution actually acquired by the ranging device 30 of the present embodiment. FIGS. 9A, 9B, and 9C illustrate examples of histograms of the number of photons (corresponding to the light reception count value) in the first shot, the second shot, and the third shot, respectively. FIG. 9D illustrates an example of a histogram acquired by accumulating the number of photons of all shots. The horizontal axis represents the elapsed time from light emission. One interval of the histogram corresponds to a period of one bin in which photon detection is performed. The vertical axis represents the number of photons detected for each bin period.

As illustrated in FIG. 9A, in the first shot, the number of photons of the sixth bin BN11 is a peak. As illustrated in FIG. 9B, in the second shot, the number of photons of the third bin BN12 is equal to the number of photons of the fifth bin BN13, and these are peaks. As illustrated in FIG. 9C, in the third shot, the number of photons of the sixth bin BN14 is a peak. In the second shot, different bins from the other shots are peaks. This is due to light reception count values due to ambient light other than the reflected light from the object 40.

As illustrated in FIG. 9D, in the histogram acquired by accumulating the number of photons of all shots, the sixth bin BN15 is a peak. This peak bin corresponds to the distance between the ranging device 30 and the object 40.

By accumulating the light reception count values of a plurality of shots, even when the light reception count value due to environmental light is included as in the second shot of FIG. 9B, it is possible to detect a bin having a high possibility of reflected light from the object 40 more accurately. Therefore, even when the light emitted from the light emitting unit 301 is weak, the ranging can be performed with high accuracy by employing a process in which a plurality of shots are repeated.

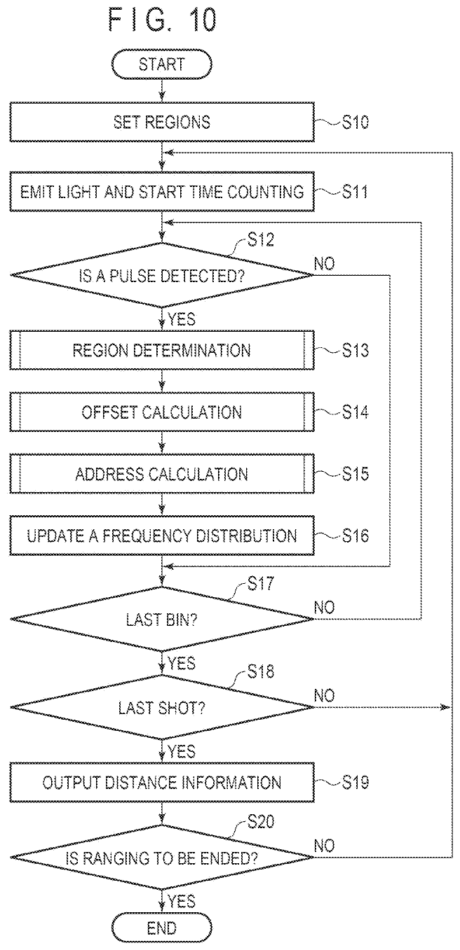

Next, a specific operation of the ranging device 30 of the present embodiment will be described with reference to a flowchart of FIG. 10. FIG. 10 is a flowchart illustrating an operation of the ranging device 30 according to the present embodiment. FIG. 10 illustrates the operation from the start to the end of the ranging period.

In step S10, the region setting unit 315 sets each region so as to divide the pixel array in which the plurality of photoelectric conversion elements are arranged into a plurality of regions. Then, for each of the regions that have been set, the distance resolution setting unit 313 sets the distance resolution of each region, that is, the class width of each bin (the length of the time interval of each bin). Further, for each of the regions that have been set, the range setting unit 314 sets the acquisition range of the frequency distribution in each region.

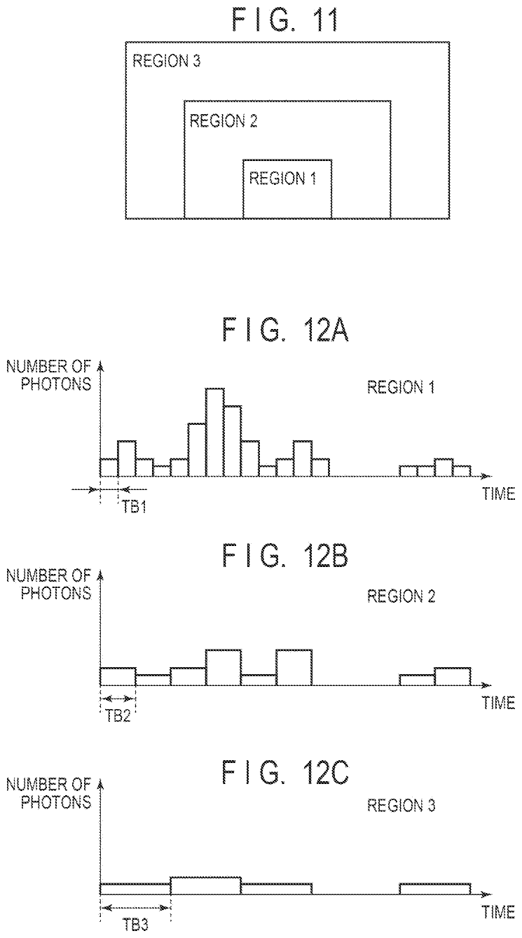

Here, with reference to FIGS. 11, 12A, 12B, and 12C, examples of the setting of the regions set in the step S10 and the frequency distribution acquired for each region will be described. FIG. 11 is a schematic diagram illustrating an example of setting regions according to the present embodiment. FIG. 11 illustrates a pixel region in which a plurality of photoelectric conversion elements are arranged. The pixel region is divided into a region 1 (first region), a region 2 (second region), and a region 3. The region 2 is arranged to surround at least a part of the region 1, and the region 3 is arranged to surround at least a part of the region 2.

FIGS. 12A, 12B, and 12C are histograms visually illustrating an example of frequency distribution of each region according to the present embodiment. FIG. 12A illustrates an example of a frequency distribution (first frequency distribution) acquired from one photoelectric conversion element in the region 1. FIG. 12B illustrates an example of a frequency distribution (second frequency distribution) acquired from one photoelectric conversion element in the region 2. FIG. 12C illustrates an example of a frequency distribution acquired from one photoelectric conversion element in the region 3.

The time interval lengths of bins in the regions 1, 2, and 3 are denoted by TB1, TB2, and TB3, respectively. Here, the time interval length TB2 of the bin (second bin) in the region 2 is twice the time interval length TB1 of the bin (first bin) in the region 1, and the time interval length TB3 of the bin in the region 3 is four times the time interval length TB1 of the bin in the region 1. When the number of bins in the frequency distribution of the region 1 is 128, the number of bins in the frequency distribution of the region 2 is 64, and the number of bins in the frequency distribution of the region 3 is 32. That is, the number of bins in the frequency distribution of region 2 is half the number of bins in the frequency distribution of region 1, and the number of bins in the frequency distribution of region 3 is one quarter of the number of bins in the frequency distribution of region 1. As described above, in the present embodiment, by setting different time intervals in each of the region 1, the region 2, and the region 3, it is possible to perform ranging with different distance resolution for each region. In the present embodiment, since frequency distributions in the same range are acquired in each region, the number of bins increases as the distance resolution increases. Further, in order to prevent the storage capacity required for storing the frequency distribution of each region from exceeding a predetermined value, the region with higher distance resolution has smaller area and has smaller number of pixels. In other words, when the regions 1 and 2 are compared, the number of bins of the region 1 is greater than the number of bins of the region 2, and the number of pixels in the region 1 is less than the number of pixels in the region 2. Since the storage capacity required for storing the frequency distribution is proportional to the product of the number of bins and the number of pixels, the storage capacity is reduced by setting them in this manner.

The operation of the ranging device 30 will be described with reference to FIG. 10 again. After the step S10, the process proceeds to step S11. A loop from the step S11 to step S20 indicates a process in which signal acquisition of one frame is performed. A loop from the step S11 to step S18 indicates a process in which signal acquisition of one shot is performed. A loop from step S12 to step S17 indicates one processing relating to detection of a pulse based on incident light.

In the step S11, the light emitting unit 301 emits light to the ranging area. At the same time, the time counting unit 312 starts time counting. Thereby, the signal acquisition processing of one shot is started. The control unit 311 controls the light emission of the light emitting unit 301 and the start of the time counting by the time counting unit 312 so as to be synchronized with each other. Thus, the elapsed time from the light emission can be counted.

The light receiving unit 302 receives light including reflected light from the object 40. The light receiving unit 302 converts the light into a pulse signal by photoelectric conversion. The rising edge of this pulse indicates that a photon is incident on the photoelectric conversion element. In the step S12, when the light receiving unit 302 detects the rising edge of the pulse (YES in the step S12), the process proceeds to step S13. When the light receiving unit 302 does not detect the rising edge of the pulse (NO in the step S12), the process proceeds to the step S17.

In the step S13, the region determination unit 317 determines a region to which the photoelectric conversion element that has detected the pulse belongs. In steps S14 and S15, the address calculation unit 316 performs a processing of calculating an address in the frequency distribution storage unit 319 for storing the light reception count value based on the incident light. In the step S14, the address calculation unit 316 calculates an offset of the region storing the light reception count value of the corresponding bin. In the step S15, the address calculation unit 316 calculates the address using the offset. The details of the processing in the steps S13 to S15 will be described later.

In step S16, the frequency distribution generation unit 318 reads data from the frequency distribution storage unit 319 based on the calculated address, adds the light reception count value acquired by the light receiving unit 302 to the data, and writes the data back to the frequency distribution storage unit 319. By this processing, the frequency distribution is updated.

In the step S17, when the current time indicated by the current time count value is before the completion time of the last bin period (NO in the step S17), the process proceeds to the step S12 and the pulse detection is continued. When the current time is after the last bin period (YES in the step S17), the process proceeds to the step S18, and the processing of one shot ends.

In the step S18, the control unit 311 determines whether or not the processing of the last shot is ended. When the processing of the last shot is ended (YES in the step S18), the processing proceeds to step S19. When the processing of the last shot is not ended (NO in the step S18), the processing proceeds to the step S11, and the operation of the next shot is started.

In the step S19, the distance calculation unit 320 reads the frequency distribution stored in the frequency distribution storage unit 319 using the address acquired from the address calculation unit 316, and converts the peak into a distance to calculate distance information. Then, the output unit 321 outputs the distance information to an external device of the ranging device 30.

In the step S20, the control unit 311 determines whether or not to end the ranging in the ranging device 30. When it is determined that the ranging is to be ended (YES in the step S20), the process ends. When it is determined that the ranging is not to be ended (NO in the step S20), the process proceeds to the step S11, and the ranging in the next frame period is started. This determination may be based on, for example, a control signal or the like from equipment on which the ranging device 30 is mounted.

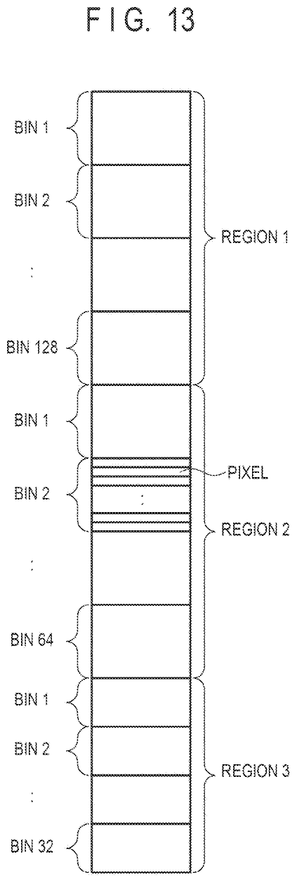

Next, the processing from the step S13 to the step S15 in FIG. 10 will be described in detail. FIG. 13 is a schematic diagram illustrating an example of assignment of addresses according to the present embodiment. The vertically aligned boxes in FIG. 13 schematically illustrate storage areas in which frequency distributions are stored. It is assumed that the address value at the top of these boxes is 0, and the address values are defined in order from the top. In FIG. 13, “region 1”, “region 2”, and “region 3” indicate storage areas in which frequency distributions acquired from photoelectric conversion elements (pixels) of corresponding region numbers are stored. In FIG. 13, “bin 1” to “bin 128” indicate storage areas in which light reception count values of corresponding bin numbers are stored. In addition, as illustrated in the “region 2” and “bin 2” of FIG. 13, the light reception count values acquired from the pixels in one region are collectively stored in the storage area of one bin without any gap. As described above, in the present embodiment, the data constituting the frequency distributions of the region 1, the region 2, and the region 3 is stored in the storage area of consecutive address values without any gap.

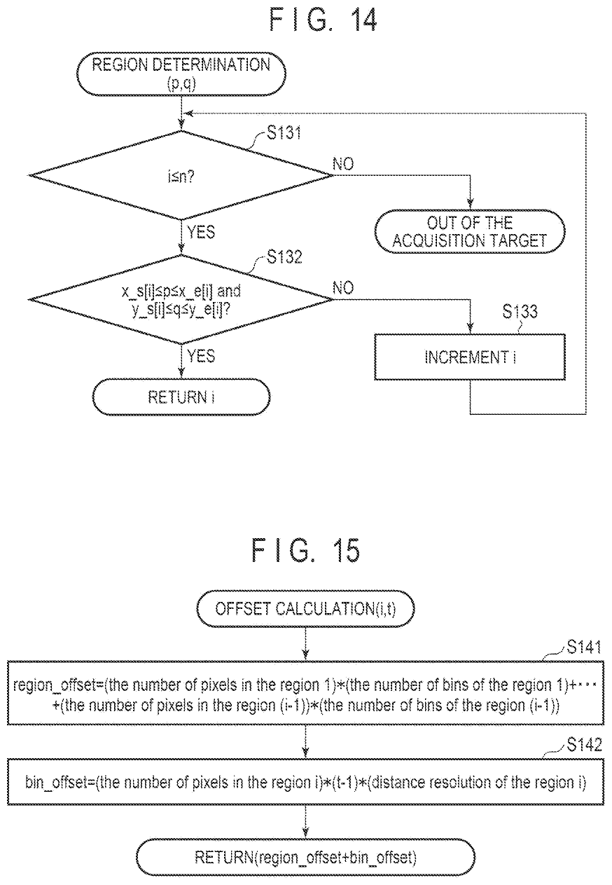

FIG. 14 is a flowchart illustrating the region determination processing according to the present embodiment. That is, the flowchart of FIG. 14 is a subroutine corresponding to the step S13 of FIG. 10. FIG. 14 illustrates a processing of determining the region number of the region to which the coordinates (p, q) belong when a pulse based on incident light is detected in the pixel of the coordinates (p, q) (the p-th pixel from the left in the horizontal direction and the q-th pixel from the top in the vertical direction). In FIG. 14, the “i” indicates a region number. Further, the “i” is a loop counter of the loop processing illustrated in FIG. 14, and the initial value is 1. The “n” in FIG. 14 indicates an upper limit value (for example, the number of divided regions) of the region number in this determination processing. In FIG. 14, “x_s[i]” and “x_e[i]” represent the x-coordinates of the pixels at the left end and the right end of the region i, respectively. In FIG. 14, “y_s[i]” and “y_e[i]” represent y-coordinates of pixels at the upper end and the lower end of the region i, respectively.

In step S131, the region determination unit 317 determines whether or not “i” is equal to or less than “n”. When “i” is equal to or less than “n” (YES in the step S131), the process proceeds to step S132 to perform region determination processing. When “i” is greater than “n” (NO in the step S131), since the pixel of the coordinates (p, q) is not included in the region 1 to the region n, it is determined that the detected pulse is out of the acquisition target of the frequency distribution, and the process ends.

In the step S132, the region determination unit 317 determines whether or not the pixel of the coordinates (p, q) is included in the region i. Specifically, the region determination unit 317 determines whether or not both of the inequality expressions of “x_s[i]≤p≤x_e[i]” and “y_s[i]≤q≤y_e[i]” are satisfied. When both of these inequality expressions are satisfied (YES in the step S132), the region determination unit 317 outputs the value of “i” at that point in time. When at least one of these inequality expressions is not satisfied (NO in the step S132), the process proceeds to step S133. In the step S133, the region determination unit 317 increments the value of “i”. After that, the process proceeds to the step S131, and the determination processing of the next region is performed.

As described above, in the region determination processing, the processing of sequentially determining whether or not the pixel of the coordinates (p, q) are included in the region from the region 1 to the region n is performed. When a region including the pixel of the coordinates (p, q) is found, the region number of the region is output from the region determination unit 317 to the address calculation unit 316.

FIG. 15 is a flowchart illustrating the offset calculation processing according to the present embodiment. The flowchart of FIG. 15 is a subroutine corresponding to the step S14 of FIG. 10. FIG. 15 illustrates a processing of calculating the start address (offset) of the bin in the storage area when the region number is “i” and the bin number is “t”. The “i” in FIG. 15 indicates the region number determined in the region determination processing in FIG. 14. Further, the “t” in FIG. 15 indicates a bin number of an offset calculation target.

As can be understood from FIG. 13, for example, the offset in the bin 2 of the region 2 corresponds to the size (memory size) of the storage area having addresses prior to the address of the bin 2 of the region 2. Therefore, the offset in bin 2 of region 2 can be calculated by “(memory size of all bins of region 1)+(memory size of bin 1 of region 2)”. The processing of FIG. 15 generalizes this calculation method.

In step S141, the address calculation unit 316 calculates an offset in units of regions (region_offset). Specifically, the offset in units of regions is calculated by an expression of “region_offset=(the number of pixels in the region 1)*(the number of bins in the region 1)+ . . . +(the number of pixels in the region (i−1))*(the number of bins of the region (i−1))”.

In step S142, the address calculation unit 316 calculates an offset in units of bins (bin_offset). Specifically, the offset in units of bins is calculated by an expression of “bin_offset=(the number of pixels in the region i)*(t−1)*(distance resolution of the region i)”. Here, the distance resolution may be a coefficient inversely proportional to the width of the time interval of the bin. For example, the value of the distance resolution of each region may be set with reference to the region 1, such that the distance resolution of the region 1 is “1”, the distance resolution of the region 2 is “½”, and the distance resolution of the region 3 is “¼”.

Then, a value acquired by adding the above-described “region_offset” and “bin_offset” is calculated as an offset.

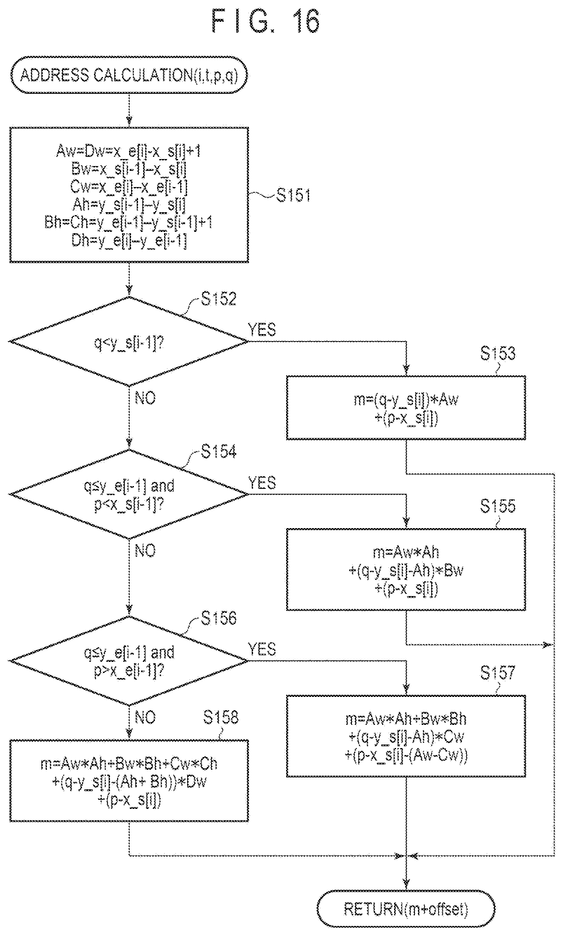

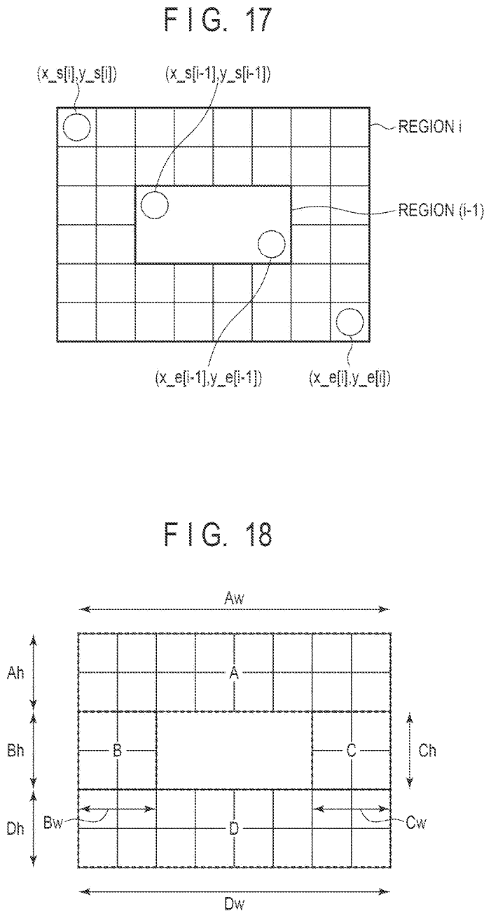

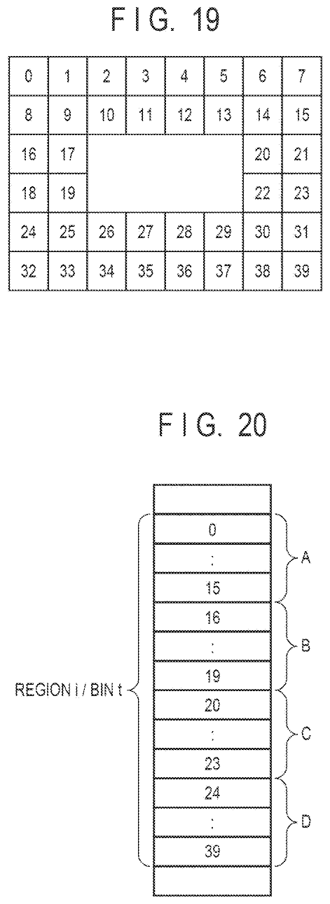

In the following, with respect to the region i and the bin t, a method of assigning addresses to a plurality of pixels in the region i and calculating an address corresponding to a pixel of coordinates (p, q) will be described. FIG. 16 is a flowchart illustrating an address calculation processing according to the present embodiment. That is, the flowchart of FIG. 16 is a subroutine corresponding to the step S15 of FIG. 10. FIG. 17 is a schematic diagram illustrating an arrangement example of a region i and a region (i−1) and an arrangement example of pixels. FIG. 18 is a schematic diagram illustrating an arrangement example of sub-regions in the region i. FIG. 19 is a schematic diagram illustrating an example of assignment of addresses to pixels in the region i. FIG. 20 is a schematic diagram illustrating an example of assignment of addresses to pixels of the region i and the bin t.

As illustrated in FIG. 17, it is assumed that the outer periphery of the region (i−1) is surrounded by the region i. Although FIG. 11 illustrates an example in which three sides of one region are surrounded by another region, FIG. 17 illustrates an example in which all four sides of the region (i−1) are surrounded by the region i in order to make the description more general. The coordinates of the upper left pixel of the region i are (x_s[i], y_s[i]), and the coordinates of the lower right pixel of the region i are (x_e[i], y_e[i]). The coordinates of the upper left pixel of the region (i−1) are (x_s[i−1], y_s[i−1]), and the coordinates of the lower right pixel of the region (i−1) are (x_e[i−1], y_e[i−1]).

As illustrated in FIG. 18, the region i is divided into four sub-regions A, B, C, and D arranged so as to surround the region (i−1). The widths (the number of pixels in the horizontal direction) of the sub-regions A, B, C, and D are denoted by Aw, Bw, Cw, and Dw, respectively. The heights (the number of pixels in the vertical direction) of the sub-regions A, B, C, and D are denoted by Ah, Bh, Ch, and Dh, respectively. In the case of the sub-region division method of FIG. 18, Aw=Dw and Bh=Ch. FIG. 19 illustrates an example in which numbers are assigned to the pixels in the region i in raster order, and addresses corresponding to the pixels are assigned in the order of the numbers. FIG. 20 illustrates the correspondence relationship between the numbers of pixels in the storage area in the region i and the bin t and the sub-regions A to D.

The processing of calculating the address corresponding to the pixel of the coordinates (p, q) will be described with reference to FIG. 16. In step S151, the address calculation unit 316 calculates the widths and heights of the sub-regions A, B, C, and D from the coordinates of the ranges of the region i and the region (i−1). This calculation processing is performed using the following expressions.

Aw=Dw=x_e[i]−x_s[i]±1

Bw=x_s[i−1]−x_s[i]

Cw=x_e[i]−x_e[i−1]

Ah=y_s[i−1]−y_s[i]

Bh=Ch=y_e[i−1]−y_s[i−1]+1

Dh=y_e[i]−y_e[i−1]

In step S152, the address calculation unit 316 determines whether or not the pixel of the coordinates (p, q) is included in the sub-region A. Specifically, the address calculation unit 316 determines whether or not an inequality expression of “q<y_s[i−1]” is satisfied. When this inequality expression is satisfied (YES in the step S152), the pixel of the coordinates (p, q) is included in the sub-region A. In this case, the process proceeds to step S153. When this inequality expression is not satisfied (NO in the step S152), the pixel of the coordinates (p, q) is not included in the sub-region A. In this case, the process proceeds to step S154.

In the step S153, the address calculation unit 316 calculates the address value m by the expression of “m=(q−y_s[i])*Aw+(p−x_s[i])”.

In the step S154, the address calculation unit 316 determines whether or not the pixel of the coordinates (p, q) is included in the sub-region B. Specifically, the address calculation unit 316 determines whether or not both of the inequality expressions of “q≤y_e[i−1]” and “p<x_s[i−1]” are satisfied. When both of these inequality expressions are satisfied (YES in the step S154), the pixel of the coordinates (p, q) is included in the sub-region B. In this case, the process proceeds to step S155. When at least one of these inequality expressions is not satisfied (NO in the step S154), the pixel of the coordinates (p, q) is not included in the sub-region B. In this case, the process proceeds to step S156.

In the step S155, the address calculation unit 316 calculates the address value m by the equation of “m=Aw*Ah+(q−y_s[i]−Ah)*Bw+(p−x_s[i])”.

In the step S156, the address calculation unit 316 determines whether or not the pixel of the coordinates (p, q) is included in the sub-region C. Specifically, the address calculation unit 316 determines whether or not both of the inequality expressions of “q≤y_e[i−1]” and “p≥x_e[i−1]” are satisfied. When both of these inequality expressions are satisfied (YES in the step S156), the pixel of the coordinates (p, q) is included in the sub-region C. In this case, the process proceeds to step S157. When at least one of these inequality expressions is not satisfied (NO in the step S156), the pixel of the coordinates (p, q) is not included in the sub-region C. Accordingly, the pixel of the coordinates (p, q) are included in the sub-region D. In this case, the process proceeds to step S158.

In the step S157, the address calculation unit 316 calculates the address value m by the expression of “m=Aw*Ah+Bw*Bh+(q−y_s[i]−Ah)*Cw+(p−x_s[i]−(Aw−Cw))”.

In the step S158, the address calculation unit 316 calculates the address value m by the expression of “m=Aw*Ah+Bw*Bh+Cw*Ch+(q−y_s[i]−(Ah+Bh))*Dw+(p−x_s[i])”.

The address calculation unit 316 adds the offset calculated in the processing of FIG. 15 to the address value m calculated in any of the above-described steps S153, S155, S157, and S158, and outputs the added value. Thereby, the frequency distribution generation unit 318 can acquire an address used for reading and writing data from and to the frequency distribution storage unit 319. According to the processing method of the address calculation unit 316 illustrated in FIGS. 16 to 20, even when a plurality of regions are set as illustrated in FIG. 17, the data can be stored in the frequency distribution storage unit 319 in a state where the data is filled so that the address cannot be blank.

In the present embodiment, as illustrated in FIG. 11, a light receiving unit 302 in which a plurality of photoelectric conversion elements (pixels) are arranged is divided into a plurality of regions. As illustrated in FIGS. 12A, 12B, and 12C, different bin class widths are set in the plurality of regions, and therefore different distance resolutions are set in the plurality of regions. In other words, in the present embodiment, it is possible to individually set the division range of the region and the class width of the bin in each region.

Here, the data amount of the frequency distribution is proportional to the product of the number of pixels and the number of bins. Therefore, by setting the range of the region and the distance resolution of each region so that the sum of the product of the number of pixels and the number of bins over a plurality of regions is constant, the storage capacity required for storing the frequency distribution is constant. Further, by setting the range of the region and the distance resolution of each region so that the sum of the product of the number of pixels and the number of bins over a plurality of regions is equal to or less than a certain value, the storage capacity required for storing the frequency distribution can be suppressed to a certain value or less. The constant value can be set to a value as small as possible within a range not exceeding the storage capacity of the frequency distribution storage unit 319. As described above, according to the present embodiment, the ranging device 30 capable of further reducing the storage area required for storing the frequency distribution is provided.

### Second Embodiment

In the first embodiment, a plurality of regions are set such that the region i surrounds the region (i−1), but the arrangement of the regions is not limited thereto. In the present embodiment, an example in which regions are periodically set in units of one pixel will be described. In the present embodiment, description of elements common to those in the first embodiment may be omitted or simplified.

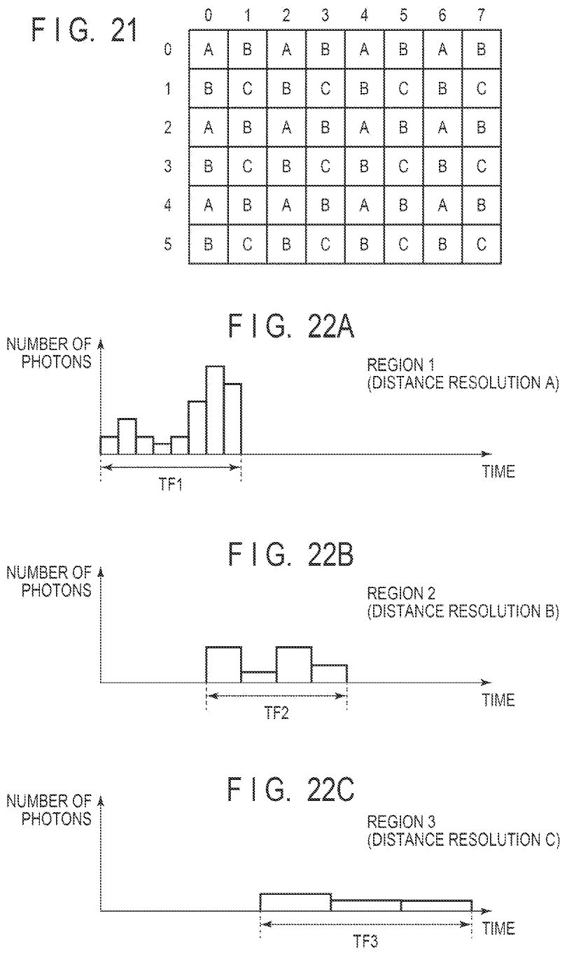

FIG. 21 is a schematic diagram illustrating an example of setting the distance resolution according to the present embodiment. FIG. 21 illustrates a setting of a distance resolution when a frequency distribution is acquired from each pixel in an array of pixels of 6 rows×8 columns. In FIG. 21, “A” denotes a pixel to which the highest resolution is set (distance resolution A). In FIG. 21, “B” denotes a pixel to which a medium resolution is set (distance resolution B). In FIG. 21, “C” denotes a pixel to which a low resolution is set (distance resolution C). Pixels to which the distance resolution A, the distance resolution B, and the distance resolution C are set are referred to as a region 1, a region 2, and a region 3, respectively. Thus, in the present embodiment, different regions are arranged alternately in one row or one column.

In the example of FIG. 21, when the coordinates of the pixel are (p, q), the distance resolution of each pixel is determined as follows. When (p mod 2)=0 and (q mod 2)=0, the distance resolution A is set. When (p mod 2)=1 and (q mod 2)=0, or when (p mod 2)=0 and (q mod 2)=1, the distance resolution B is set. When (p mod 2)=1 and (q mod 2)=1, the distance resolution C is set. Note that (j mod k) means a remainder obtained by dividing the integer j by the integer k. That is, (j mod 2)=0 indicates that the integer j is an even number, and (j mod 2)=1 indicates that the integer j is an odd number.

FIGS. 22A, 22B, and 22C are histograms visually illustrating an example of frequency distribution of each region according to the present embodiment. Also in this embodiment, similarly to FIGS. 12A, 12B, and 12C of the first embodiment, by setting different time intervals in each of the region 1, the region 2, and the region 3, ranging is performed with different distance resolution for each region. In the present embodiment, the periods TF1, TF2, and TF3 during which frequency distributions are acquired in the region 1, the region 2, and the region 3 are different from each other. Specifically, the period TF1 is set to a period corresponding to a short distance, the period TF2 is set to a period corresponding to a middle distance, and the period TF3 is set to a period corresponding to a long distance. By setting the acquisition period of the frequency distribution and the distance resolution in this manner, the ranging can be performed at the short distance with a high distance resolution and the ranging can be performed at the long distance with a low distance resolution. This method is effective in applications in which a higher distance resolution is required for a shorter distance, such as for vehicles.

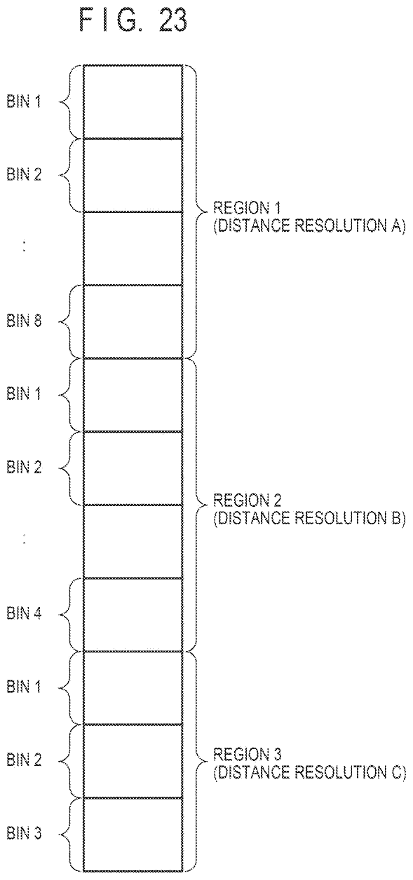

FIG. 23 is a schematic diagram illustrating an example of assignment of addresses according to the present embodiment. As in FIG. 13 of the first embodiment, in the present embodiment, addresses are sequentially assigned to each region and each bin.

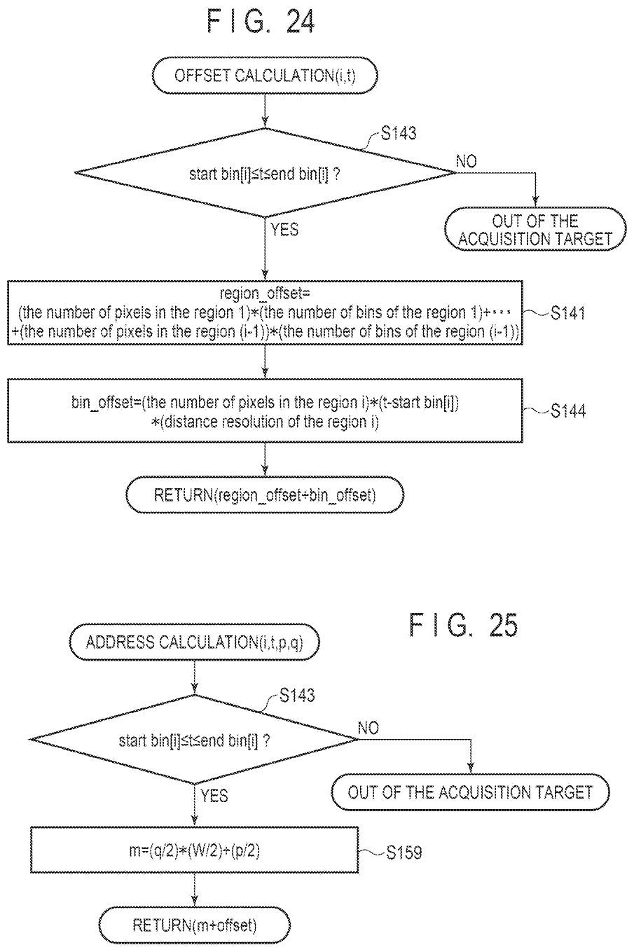

FIG. 24 is a flowchart illustrating offset calculation processing according to the present embodiment. The flowchart of FIG. 24 is a subroutine corresponding to the step S14 of FIG. 10, and a description of the same processing as in FIG. 15 will be appropriately omitted.

In step S143, the address calculation unit 316 determines whether or not the bin to be calculated is within the acquisition target range of the frequency distribution. For this determination, a start bin [i] and an end bin [i] of the acquisition range in the region i can be used. In FIGS. 22A, 22B, and 22C, the start bin [i] is a bin at the left end of each of the periods TF1, TF2, and TF3, and the end bin [i] is a bin at the right end of each of the periods TF1, TF2, and TF3. Specifically, the address calculation unit 316 determines whether or not the inequality expression of “(start bin [i])≤t≤(end bin [i])” is satisfied for the start bin [i] and the end bin [i] of the acquisition range in the region i. When this inequality expression is satisfied (YES in the step S143), the process proceeds to step S141. When this inequality expression is not satisfied (NO in the step S143), the process ends because they are out of the acquisition range.

In the step S141, the address calculation unit 316 calculates an offset in units of regions (region_offset). This processing is similar to that illustrated in FIG. 15.

In step S144, the address calculation unit 316 calculates an offset in units of bins (bin_offset). Specifically, the offset in units of bins is calculated by the expression of “bin_offset=(the number of pixels in the region i)*(t−start bin [i])*(distance resolution of the region i)”.

Then, a value acquired by adding the above-described “region_offset” and “bin_offset” is calculated as an offset.

FIG. 25 is a flowchart illustrating an address calculation processing according to the present embodiment. The flowchart of FIG. 25 is a subroutine corresponding to the step S15 of FIG. 10, and a description of the same processing as in FIGS. 16 and 24 is appropriately omitted.

In step S143, the address calculation unit 316 performs the same determination as in the step S143 of FIG. 24.

In step S159, the address calculation unit 316 calculates the address value “m” by the expression of “m=(q/2)*(W/2)+(p/2)”. Note that the “W” is the number of columns of pixels (the number of pixels in the horizontal direction in the entire region), and the “W” is eight in the example of FIG. 21.

The address calculation unit 316 adds the offset calculated in the processing of FIG. 24 to the address value m calculated in the step S159 and outputs the added value. Thereby, the frequency distribution generation unit 318 can acquire an address used for reading and writing data from and to the frequency distribution storage unit 319.

As described above, also in the present embodiment, similarly to the first embodiment, the ranging device 30 capable of further reducing the storage area required for storing the frequency distribution is provided. Further, in the present embodiment, processing such as setting a plurality of regions and calculating an address in consideration of the plurality of regions can be simplified as compared with the first embodiment.

### Third Embodiment

In the present embodiment, an example in which a range of a plurality of regions can be dynamically changed will be described. In the present embodiment, description of elements common to those in the first embodiment may be omitted or simplified.

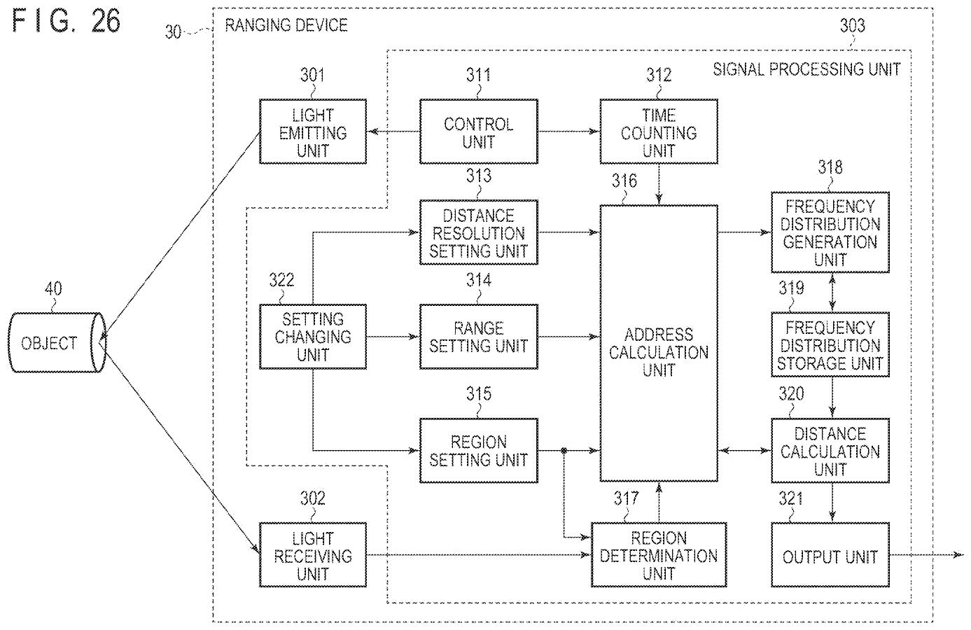

FIG. 26 is a functional block diagram illustrating a schematic configuration example of the ranging device 30 according to the present embodiment. The signal processing unit 303 of the ranging device 30 of the present embodiment includes a setting changing unit 322 in addition to the configuration of the signal processing unit 303 of the first embodiment. The setting changing unit 322 controls to change the setting of at least one of the distance resolution setting unit 313, the range setting unit 314, and the region setting unit 315 based on external information indicating an external situation of the ranging device 30.

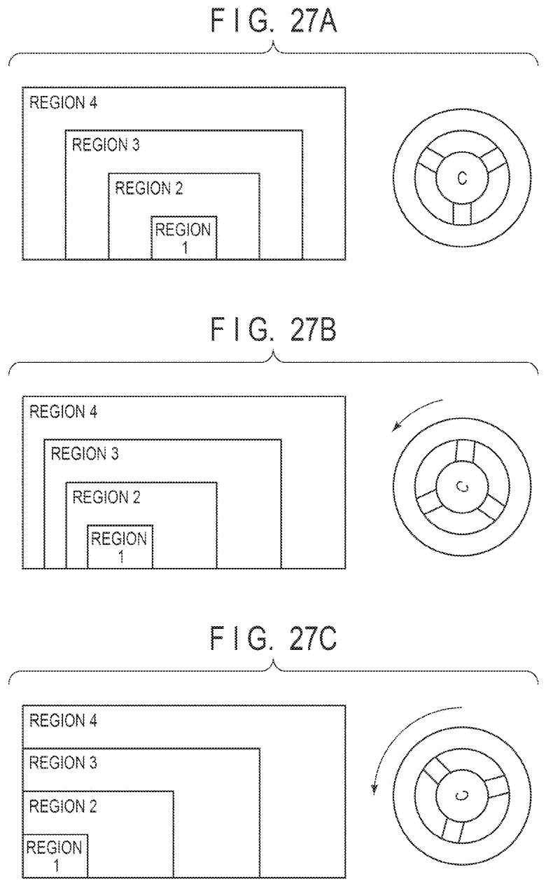

As an example of the control by the setting changing unit 322, an example in which positions of the regions are changed in accordance with the rotation angle of the steering wheel of a vehicle (e.g., an automobile) on which the ranging device 30 is mounted will be described. In this example, the setting changing unit 322 acquires information indicating the rotation angle of the steering wheel (the steering direction of the moving body) from the control device of the vehicle. FIGS. 27A, 27B, and 27C are schematic diagrams illustrating examples of changing settings of regions according to the present embodiment. FIG. 27A illustrates ranges from the region 1 to the region 4 when the rotation angle of the steering wheel is zero degree. As in the first embodiment, it is assumed that the frequency distribution is acquired with a higher distance resolution as the region number is smaller.

FIG. 27B illustrates ranges from region 1 to region 4 when the rotation angle of the steering wheel is 30 degrees to the left. As illustrated in FIG. 27B, the region 1 moves in parallel to the left in comparison with the case where the rotation angle is zero degree, and the ranges of the region 2, the region 3, and the region 4 also change in accordance with the parallel movement of the region 1. FIG. 27C illustrates ranges from region 1 to region 4 when the rotation angle of the steering wheel is 60 degrees to the left. As illustrated in FIG. 27C, the region 1 further moves in parallel to the left in comparison with the case where the rotation angle is 30 degrees, and the left end of the region 1 coincides with the left end of the region 4. Accordingly, the range of each region changes so that the left end of the region 2 and the left end of the region 3 also coincide with the left end of the region 4. Thus, the setting changing unit 322 controls the region setting unit 315 to change the position of each region depending on the rotation angle of the steering wheel. Thus, since the centers of the region 1, the region 2, and the region 3 approach the traveling direction of the vehicle, the distance resolution in the vicinity of the traveling direction of the vehicle is increased.

Since the state of FIG. 27C is the limit of the region movement, the range of each region does not change any more even if the steering wheel is moved to the left by 60 degrees or more. The amount of movement of region 1 with respect to the rotation angle of the steering wheel may be, for example, 100 pixels at 30 degrees and 300 pixels at 60 degrees.

It is desirable that the number of pixels included in each region do not change when each region is changed as described above. By moving the regions so that the number of pixels does not change, the range of the regions can be changed while maintaining the storage capacity required for storing the frequency distribution constant. As described above, also in the present embodiment, similarly to the first embodiment, the ranging device 30 capable of further reducing the storage area required for storing the frequency distribution is provided. Further, in the present embodiment, the ranging condition can be dynamically changed according to the external situation of the ranging device 30.

### Fourth Embodiment

In the present embodiment, another example of a configuration in which the ranges of a plurality of regions described in the third embodiment can be dynamically changed will be described. In the present embodiment, the number of pixels in each region is dynamically changed in accordance with the traveling speed of the vehicle (moving speed of the moving body). In this embodiment, description of elements common to those of the third embodiment may be omitted or simplified.

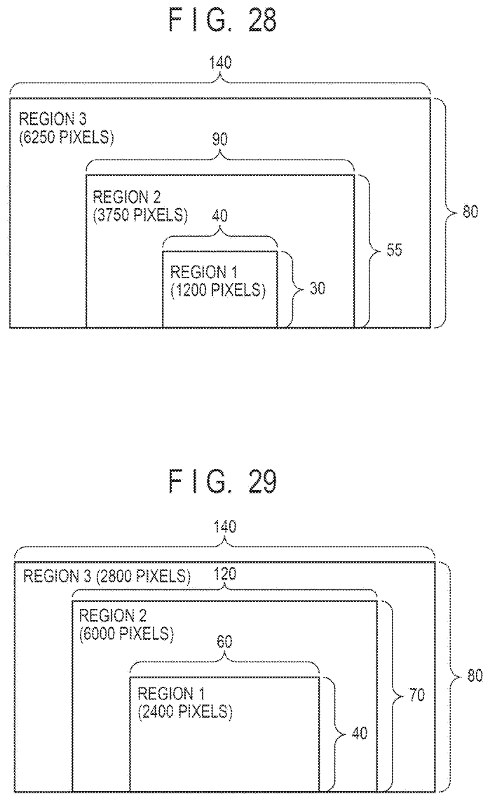

In the present embodiment, similarly to the third embodiment, it is assumed that the ranging device 30 includes the setting changing unit 322 illustrated in FIG. 26. FIGS. 28 and 29 are schematic diagrams illustrating an example of setting of regions according to the present embodiment. FIG. 28 illustrates the setting of regions when the traveling speed of the vehicle is 50 km/h. The outer periphery of the region 1 has a size of 40 pixels×30 pixels, and the total number of pixels of the region 1 is 1200. The outer periphery of the region 2 has a size of 90 pixels×55 pixels, and the total number of pixels of the region 2 is 3750. The outer periphery of the region 3 has a size of 140 pixels×80 pixels, and the total number of pixels of the region 3 is 6250. The number of bins of the frequency distribution corresponding to the region 1, the region 2, and the region 3 is 128, 64, and 32, respectively. In this case, the total memory amount (the total of (the number of pixels)×(the number of bins)) required for storing the frequency distribution is 593600.

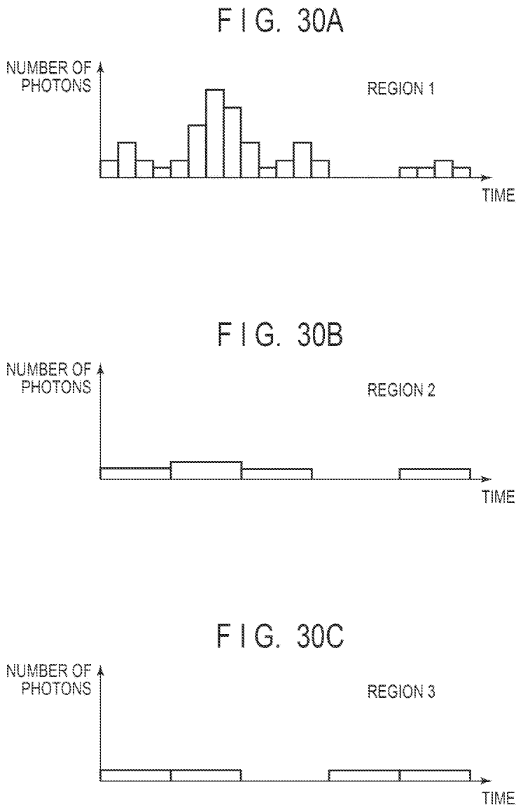

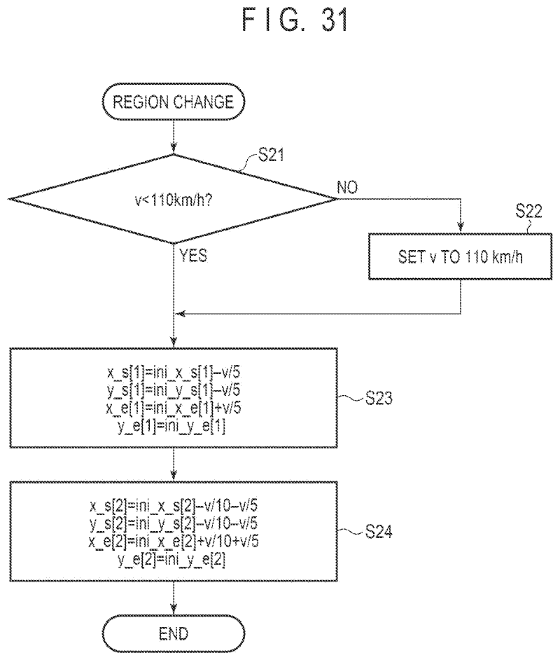

FIG. 29 illustrates the setting of the region when the traveling speed of the vehicle is 100 km/h. The outer periphery of the region 1 has a size of 60 pixels×40 pixels, and the total number of pixels of the region 1 is 2400. The outer periphery of the region 2 has a size of 120 pixels×70 pixels, and the total number of pixels of the region 2 is 6000. The outer periphery of the region 3 has a size of 140 pixels×80 pixels, and the total number of pixels of the region 3 is 2800. The number of bins of the frequency distribution corresponding to the region 1, the region 2, and the region 3 is 128, 32, and 32, respectively. In this case, the total memory amount (the total of (the number of pixels)×(the number of bins)) required for storing the frequency distribution is 588800. FIGS. 30A, 30B, and 30C are histograms visually illustrating an example of the frequency distribution of each region when the traveling speed of the vehicle is 100 km/h. As illustrated in FIGS. 30A, 30B and 30C, different bin numbers may be set between regions.

As described above, in the present embodiment, the size of the region changes according to the traveling speed of the vehicle. Since the time to approach the object 40 becomes shorter as the traveling speed is higher, it is desirable to set a wide range of region with higher distance resolution.

Further, in the present embodiment, in addition to this, the number of bins is adjusted so that the memory amount does not become excessive when the region is changed. Therefore, even if the region is changed, the memory amount does not change much.

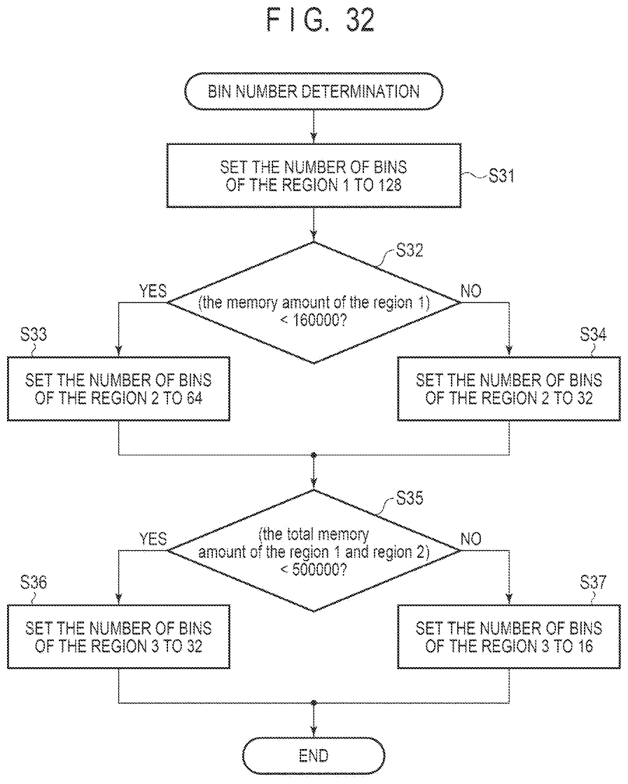

Next, a method of setting the regions and the number of bins according to the traveling speed of the vehicle as described above will be described. FIG. 31 is a flowchart illustrating a region changing method according to the present embodiment. FIG. 32 is a flowchart illustrating a determination method of the number of bins according to the present embodiment. The processing of FIGS. 31 and 32 may be performed before acquiring the frequency distribution. The processing of FIGS. 31 and 32 may be performed, for example, before the processing of the step S10 in FIG. 10, before the processing of the step S11, or may be a part of the processing of the step S10.

First, the region changing processing will be described with reference to FIG. 31. In step S21, the setting changing unit 322 acquires information on the traveling speed of the vehicle from the control device of the vehicle. Then, the setting changing unit 322 determines whether or not the traveling speed v of the vehicle is less than 110 km/h. When the traveling speed v is less than 110 km/h (YES in the step S21), the process proceeds to step S23. When the traveling speed v is equal to or greater than 110 km/h (NO in the step S21), the process proceeds to step S22.

In the step S22, the setting changing unit 322 sets the value of “v” to be used in the subsequent calculation processing, assuming that the traveling speed v is 110 km/h.

In the step S23, the setting changing unit 322 sets the coordinates (x_s[1], y_s[1]) of the upper left pixel of the region 1 and the coordinates (x_e[1], y_e[1]) of the lower right pixel of the region 1. This processing is performed using the following expressions. Note that the coordinates with “ini” such as ini_x_s[1] are initial values of various coordinates. The initial values can be, for example, coordinates when the traveling speed v is 0 km/h.

x_s[1]=ini_x_s[1]−v/5

y_s[1]=ini_y_s[1]−v/5

x_e[1]=ini_x_e[1]+v/5

y_e[1]=ini_y_e[1]

In step S24, the setting changing unit 322 sets the coordinates (x_s[2], y_s[2]) of the upper left pixel of the region 2 and the coordinates (x_e[2], y_e[2]) of the lower right pixel of the region 2. This processing is performed using the following expressions.

x_s[2]=ini_x_s[2]−v/10−v/5

y_s[2]=ini_y_s[2]−v/10−v/5

x_e[2]=ini_x_e[2]+v/10+v/5

y_e[2]=ini_y_e[2]

As described above, the coordinates of the region 1 and the region 2 are set such that the region 1 and the region 2 are larger as the traveling speed of the vehicle is higher. The changed coordinates acquired in this manner are used by the region setting unit 315 to set each region.

Next, the bin number determination processing will be described with reference to FIG. 32. In this processing, the number of bins is determined so that the memory amount does not become excessive for each region after the change of the regions by the region change processing of FIG. 31. In step S31, the setting changing unit 322 sets the number of bins of the region 1 to 128.

In step S32, the setting changing unit 322 determines whether or not the memory amount ((the number of pixels)×(the number of bins)) of the region 1 is less than 160000. When the memory amount of the region 1 is less than 160000 (YES in the step S32), the process proceeds to step S33. In the step S33, the setting changing unit 322 sets the number of bins of the region 2 to 64. When the memory amount of the region 1 is not less than 160000 (NO in the step S32), the process proceeds to step S34. In the step S34, the setting changing unit 322 sets the number of bins of the region 2 to 32.

In step S35, the setting changing unit 322 determines whether or not the total memory amount of the region 1 and the region 2 is less than 500000. When the total memory amount of the region 1 and the region 2 is less than 500000 (YES in the step S35), the process proceeds to step S36. In the step S36, the setting changing unit 322 sets the number of bins of the region 3 to 32. When the total memory amount of the region 1 and the region 2 is equal to or greater than 500000 (NO in the step S35), the process proceeds to step S37. In the step S37, the setting changing unit 322 sets the number of bins of the region 3 to 16.

As described above, also in the present embodiment, similarly to the first embodiment, the ranging device 30 capable of further reducing the storage area required for storing the frequency distribution is provided. Further, in the present embodiment, similar to the third embodiment, the ranging condition can be dynamically changed according to the external situation of the ranging device 30. Further, in the processing of setting the number of bins according to the present embodiment, by changing the number of bins according to the size of the region, the capacity of the frequency distribution can be prevented from becoming excessive.

In the third embodiment and the fourth embodiment, the steering direction of the moving body and the moving speed of the moving body are exemplified as examples of the external situation considered in the setting changing unit 322, but the external situation is not limited thereto. Other examples of the external situation considered by the setting changing unit 322 include a brightness around the ranging device and a moving speed of an object of ranging. When the surroundings of the ranging device is dark, or when the moving speed of the object is fast, it is required to perform the ranging with higher accuracy over a wide range, and therefore, it is desirable to set a wide range of a region with high distance resolution.

### Fifth Embodiment

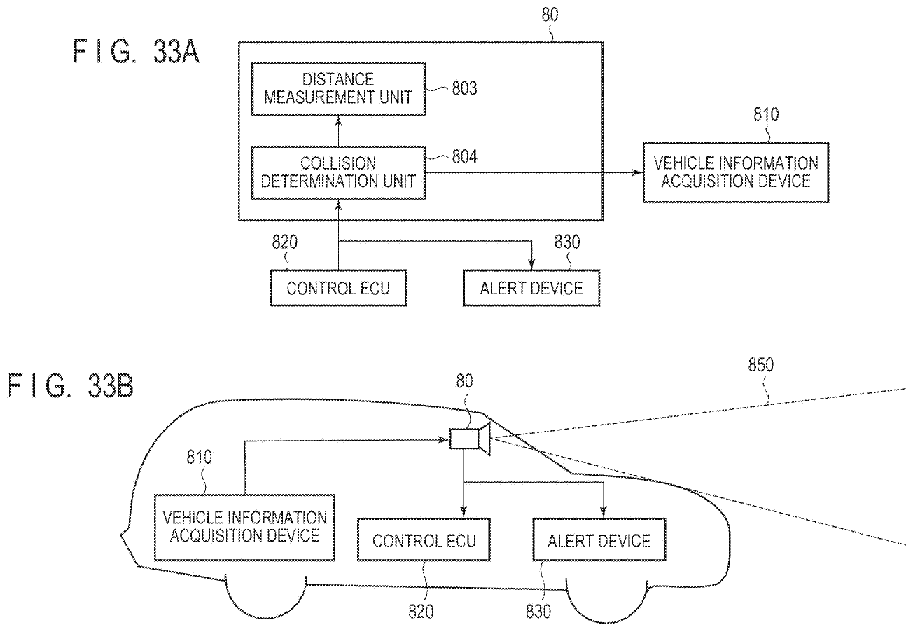

FIGS. 33A and 33B are block diagrams of equipment relating to an in-vehicle ranging device according to the present embodiment. Equipment 80 includes a distance measurement unit 803, which is an example of the ranging device of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 33B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiment, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-128616, filed Aug. 12, 2022, which is hereby incorporated by reference herein in its entirety.

What is claimed is:

1. A ranging device comprising:
a light receiving unit configured to generate a light reception count value corresponding to each of a plurality of photoelectric conversion elements by counting pulses based on incident light to each of the plurality of photoelectric conversion elements;
a time counting unit configured to count elapsed time;
a frequency distribution storage unit configured to store a frequency distribution of the number of pulses detected in each predetermined bin period in time counting for each of the plurality of photoelectric conversion elements;
a region setting unit configured to set a first region in which a part of the plurality of photoelectric conversion elements is arranged and a second region in which another part of the plurality of photoelectric conversion elements is arranged; and
a storage condition setting unit configured to set a storage condition of frequency distributions so that a class width of a first bin in a first frequency distribution corresponding to a photoelectric conversion element of the first region and a class width of a second bin in a second frequency distribution corresponding to a photoelectric conversion element of the second region are different and so that a storage capacity in which the first frequency distribution and the second frequency distribution are stored in the frequency distribution storage unit does not exceed a predetermined value.

2. The ranging device according to claim 1 further comprising:
a light emitting unit configured to emit light to an object; and
a control unit configured to synchronously control a timing at which the light emitting unit emits light and a timing at which the time counting unit starts time counting.

3. The ranging device according to claim 1, wherein the number of the first bins in one first frequency distribution is greater than the number of the second bins in one second frequency distribution.

4. The ranging device according to claim 3, wherein the number of the plurality of photoelectric conversion elements in the first region is less than the number of the plurality of photoelectric conversion elements in the second region.

5. The ranging device according to claim 1, wherein the storage condition setting unit sets the storage condition so that a sum of a product of the number of photoelectric conversion elements in the first region and the number of first bins and a product of the number of photoelectric conversion elements in the second region and the number of second bins does not exceed a predetermined value.

6. The ranging device according to claim 1, wherein the first region is a region corresponding to ranging of a shorter distance than the second region.

7. The ranging device according to claim 1,
wherein the plurality of photoelectric conversion elements are arranged to form a plurality of rows and a plurality of columns, and
wherein the second region is arranged to surround at least a part of the first region.

8. The ranging device according to claim 1,
wherein the plurality of photoelectric conversion elements are arranged to form a plurality of rows and a plurality of columns, and
wherein the first regions and the second regions are alternately arranged in one row or one column.

9. The ranging device according to claim 1 further comprising a setting changing unit configured to change a setting in the region setting unit or the storage condition setting unit based on external information indicating an external situation of the ranging device.

10. The ranging device according to claim 9, wherein the external information is at least one of a steering direction of a movable body on which the ranging device is mounted, a moving speed of the movable body, a brightness around the ranging device, and a moving speed of an object of ranging.

11. The ranging device according to claim 9, wherein the setting changing unit controls the region setting unit to change ranges of the first region and the second region based on a steering direction of a movable body on which the ranging device is mounted.

12. The ranging device according to claim 9, wherein the region setting unit controls the region setting unit to change ranges of the first region and the second region and controls the storage condition setting unit to change a setting of the storage condition based on a moving speed of a movable body on which the ranging device is mounted.

13. The ranging device according to claim 1, wherein data constituting the second frequency distribution is stored in a storage area of consecutive addresses in the frequency distribution storage unit.

14. The ranging device according to claim 1 further comprising an address calculation unit configured to calculate an address at which data is read and written in the frequency distribution storage unit based on ranges of the first region and the second region, the storage condition, and a position of the photoelectric conversion element that has detected the pulse.

15. The ranging device according to claim 1 further comprising a region determination unit configured to determine whether or not a position of the photoelectric conversion element that has detected the pulse belongs to the first region or the second region.

16. A movable body comprising:
the ranging device according to claim 1; and
a movable body control unit configured to control the movable body based on distance information acquired by the ranging device.
